(19) United States
(12) Patent Application Publication
(10) Pub. No.: US 2008/0180565 A1
(43) Pub. Date: Jul. 31, 2008

(54) ELECTRONIC EQUIPMENT SYSTEM WITH FUEL CELLS

(75) Inventor: Akihiro Sakai, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/017,900

(22) Filed: Jan. 22, 2008

(30) Foreign Application Priority Data
Jan. 30, 2007 (JP) 2007-019987

(51) Int. Cl. H04N 5/63; G03B 7/26

(52) U.S. Cl. 348/372; 396/279; 348/E05.127

(57) ABSTRACT

Provided is an electronic equipment system having fuel cells which enables simplification of the system and improvement of power generation efficiency. The electronic equipment system includes an electronic equipment body, a connection device connected to the electronic equipment body, independent power generation cells each disposed to the electronic equipment body and to the connection device, and a fuel storage vessel disposed to the electronic equipment body, in which fuel from the fuel storage vessel is suppliable to each of the independent power generation cells.

### BACKGROUND OF THE INVENTION

1. Field of the Invention

The present invention relates to an electronic equipment system having fuel cells, and more particularly, to a camera system in which fuel cells are provided to a camera body and a connection device connected to the camera body.

2. Description of the Related Art

A fuel cell can output a larger amount of electric power than that of a secondary battery of the same volume. Accordingly, application of the fuel cell is advanced to automobiles and portable electronic equipment such as notebook personal computers, mobile phones, digital cameras, and digital camcorders.

Of those, regarding the electronic equipment whose portability is a significant concern, such as the digital camera, in order to improve the portability of the fuel cell, size reduction thereof, ensuring of the volume of a battery part of the fuel cell for enduring long term use incompatible with the size reduction, a structure with a high power generation efficiency, and the like are under development.

As a technology for solving those problems, in Japanese Patent Application Laid-Open No. 2001-142124, there is proposed a camera system having a structure in which, in order to obtain an interchangeable lens type camera having a high space efficiency, a camera body and a lens barrel are each provided with an independent power supply battery.

Further, in Japanese Patent Application Laid-Open No. H05-107611, there is proposed a camera system having a structure in which, in order to effectively use multiple batteries, the operation of each of the batteries is controlled.

However, the above-mentioned electronic equipment systems including the batteries according to the background art have the following problems.

For example, with a single lens reflex camera having a structure in which a battery is included not only in the camera body, but also in each of connection devices connected to the camera body, such as an interchangeable lens and a strobe light (or strobe or electronic flash), it is necessary that electric power be supplied to the devices having the batteries for charging.

At that time, there is a need for dual battery control of detecting a remaining amount of the battery in each of the devices and determining the state of each of the batteries to control electric power supply, which makes the battery control complicated.

### SUMMARY OF THE INVENTION

The present invention is directed to an electronic equipment system in which fuel cells are provided to an electronic equipment body and a connection device connected to the electronic equipment body, and in which detection of a battery remaining amount and control of electric power supply can be performed under unified management, thereby enabling simplification of the electronic equipment system and improvement of power generation efficiency thereof.

The present invention provides an electronic equipment system having fuel cells configured as described below.

According to the present invention, there is provided an electronic equipment system including an electronic equipment body, a connection device connected to the electronic equipment body, independent power generation cells each disposed to the electronic equipment body and to the connection device, and a fuel storage vessel disposed to the electronic equipment body, in which fuel from the fuel storage vessel is suppliable to each of the independent power generation cells.

Further, according to the present invention, the electronic equipment system includes a camera system and the connection device connected to a camera body includes an interchangeable lens or a strobe light which can be connected to the camera body, and as one of the independent power generation cells, a body power generation cell, a lens driving power generation cell, and a strobe light power generation cell are disposed to the camera body, the interchangeable lens, and the strobe light, respectively.

According to the present invention, in the electronic equipment system including fuel cells provided to the electronic equipment body and to the connection device connected to the electronic equipment body, detection of a battery remaining amount and control of electric power supply can be performed under unified management, thereby enabling simplification of the electronic equipment system and improvement in power generation efficiency thereof.

Further, according to the present invention, there can be adopted a structure in which, on the electronic equipment body itself, a minimal power supply required for driving the electronic equipment body is mounted, while to the connection device itself such as an interchangeable lens, a minimal required power supply is provided. Accordingly, optimum arrangements of the power supplies for the electronic equipment body and the connection device can be attained.

As a result, the electronic equipment system can be realized, in which the electronic equipment body is not affected by a load and electric power consumption of the connection device to be connected thereto, and with which both reduction in size and cost of the electronic equipment body itself and the connection device itself are achieved.

Further features of the present invention will become apparent from the following description of exemplary embodiments with reference to the attached drawings.

### BRIEF DESCRIPTION OF THE DRAWINGS

FIG. 1 is a schematic perspective view illustrating a camera system including a fuel cell according to an embodiment of the present invention.

FIG. 2 is a schematic cross-sectional view illustrating a lens driving power generation cell according to an embodiment of the present invention.

FIG. 3 is a schematic cross-sectional view illustrating a combined state where an interchangeable lens is mounted on a camera body according to an embodiment of the present invention.

FIG. 4 is a schematic cross-sectional view illustrating a state where the interchangeable lens is not mounted on the camera body according to the embodiment of the present invention.

FIG. 5 is a schematic cross-sectional view illustrating a state when detaching the interchangeable lens according to the embodiment of the present invention.

FIG. 6 is a block diagram illustrating a system in which the interchangeable lens and a strobe light device are connected to the camera body according to the embodiment of the present invention.

FIG. 7, which is composed of FIGS. 7A and 7B, is a flow chart when the camera system according to the embodiment of the present invention is activated and operates.

FIG. 8 is a graphical representation illustrating a relationship between electric power consumptions when an interchangeable lens and a strobe light as connection devices are mounted on a camera body according to the embodiment of the present invention.

### DESCRIPTION OF THE EMBODIMENTS

The best mode for carrying out the present invention will be described by the following embodiments.

Incidentally, the term “disposed to” as herein employed is intended to generically include “disposed in”, “disposed on”, “disposed at” and the like.

As an example of an electronic equipment system to which the present invention is applied, a camera system including a fuel cell will be described.

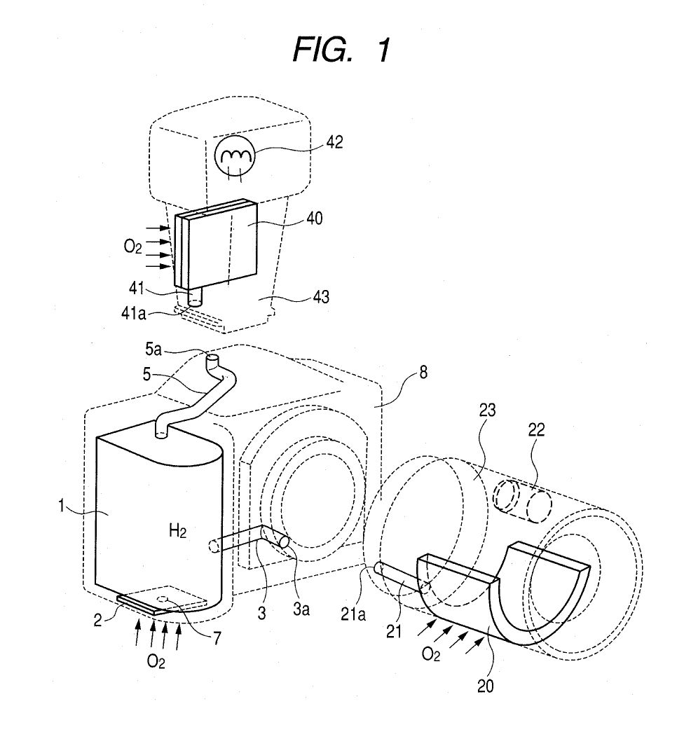

FIG. 1 is a schematic perspective view illustrating the camera system according to this embodiment.

In FIG. 1, there are illustrated a camera body 8 which is an electronic equipment shown by the dash line, and an interchangeable lens 23 and a strobe light 43 which are connection devices functioning by being connected to the camera body 8.

In FIG. 1, there are illustrated a fuel tank 1 (hydrogen storage alloy vessel), a body power generation cell 2, a hydrogen fuel flow path (for interchangeable lens) 3, a hydrogen fuel flow path opening 3a, a hydrogen fuel flow path (for strobe light) 5, a hydrogen fuel flow path opening 5a, and a hydrogen fuel flow path 7.

There are also illustrated the camera body 8, a lens driving power generation cell 20, a hydrogen fuel flow path 21, a lens motor 22, and an interchangeable lens 23.

There are further illustrated a strobe light power generation cell 40, a hydrogen fuel flow path 41, a hydrogen fuel flow path opening 41a, a strobe light emitting element 42, and a strobe light 43.

In this embodiment, in the camera body 8, as a fuel storage vessel, the fuel tank 1 for storing hydrogen fuel for the fuel cell is disposed, and the fuel tank 1 is charged with a hydrogen storage alloy.

In a lower portion of the camera body 8, there is provided the body power generation cell 2 for driving the camera body 8.

The interchangeable lens 23 and the strobe light 43 which are the connection devices are provided with the lens driving power generation cell 20 and the strobe light power generation cell 40, respectively.

In this embodiment, the independent power generation cells are disposed on the camera body 8, and the connection devices such as the interchangeable lens 23 and the strobe light 43, respectively, as described above.

The fuel from the fuel tank 1 (hydrogen storage alloy vessel) which is the fuel storage vessel can be supplied to the independent power generation cells, respectively.

That is, when the interchangeable lens 23 and the camera body 8 are combined with each other, the tubular fuel flow path opening 3a and the fuel flow path opening 21a are coupled with each other, thereby allowing the fuel to flow through the fuel flow path.

By a pressure in the fuel tank, the fuel in the fuel tank 1 is supplied to the lens driving power generation cell 20 to perform power generation.

When the strobe light power generation cell 40 and the camera body 8 are combined with each other, the tubular fuel flow path opening 5a and the fuel flow path opening 41a are coupled with each other, thereby allowing the fuel to flow through the fuel flow path.

By the pressure in the fuel tank, the fuel in the fuel tank 1 is supplied to the strobe light power generation cell 40 to perform power generation.

Next, the power generation cells according to this embodiment will be further described.

Each of the body power generation cell 2, the lens driving power generation cell 20, and the strobe light power generation cell 40 shown in FIG. 1 has the same single cell structure and has a power generation cell size corresponding to a level of the electric power consumption of each of the connection devices.

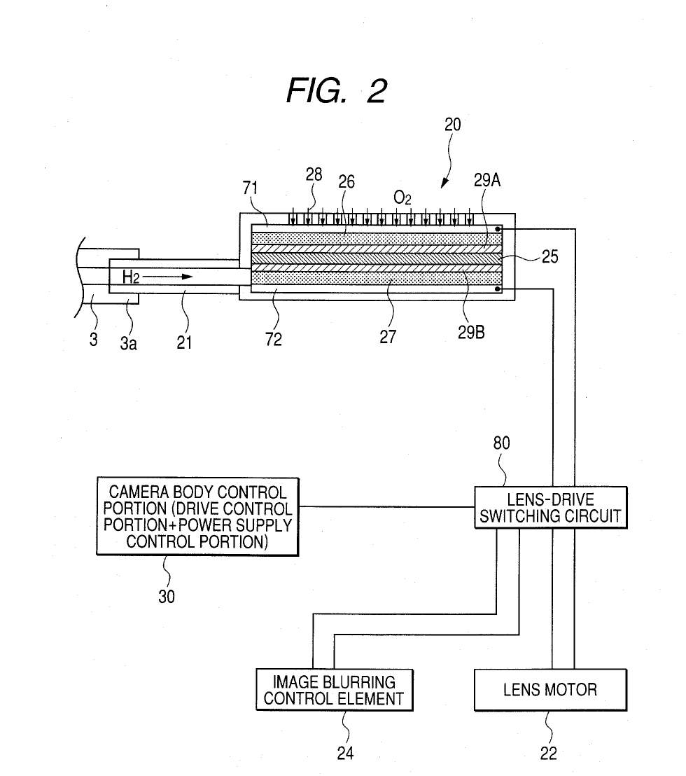

FIG. 2 is a schematic cross-sectional view illustrating the lens driving power generation cell as a representative example of the power generation cell. In FIG. 2, the elements which are the same as those shown in FIG. 1 are identified by like numerals or characters. Accordingly, the explanation of the common elements will be omitted.

In FIG. 2, there are illustrated an image blurring control element 24, an electrolyte layer 25, an oxygen gas diffusion layer 26, a hydrogen gas diffusion layer 27, oxygen supply holes 28, an oxygen electrode-side catalyst layer 29A, and a hydrogen fuel electrode-side catalyst layer 29B.

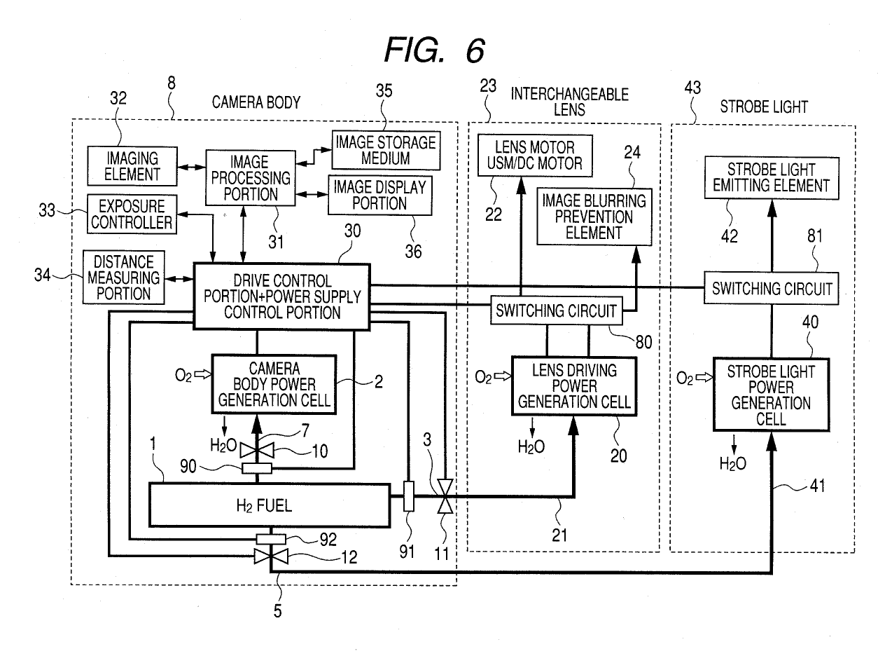

As illustrated in FIG. 2, a hydrogen gas H₂ supplied at a pressure higher than the atmospheric pressure from the fuel tank 1 is controlled for flow rate by a fuel flow rate control valve 11 (see FIG. 6) to be allowed to pass through the hydrogen fuel flow path 3 and the hydrogen fuel flow path 21.

The hydrogen gas H₂ which has passed through the hydrogen fuel supply path of the lens driving power generation cell 20 arrives at the hydrogen gas diffusion layer 27 and is supplied to the hydrogen fuel electrode-side catalyst layer 29B.

On the hydrogen fuel electrode side of the electrolyte membrane 25, there are disposed the hydrogen fuel electrode-side catalyst layer 29B, the hydrogen gas diffusion layer 27 formed of a conductive porous body such as carbon cloth, and the hydrogen flow path 21 for supplying hydrogen thereto.

On the other hand, on the oxygen electrode side of the electrolyte membrane 25, there are disposed the oxygen electrode-side catalyst layer 29A and the oxygen gas diffusion layer 26 formed of a conductive porous body such as a foamed metal. In a case of the lens driving power generation cell 20, the oxygen supply holes 28 for supplying oxygen are provided.

The hydrogen fuel H₂ which has been supplied from the fuel tank 1 of the camera body and has arrived at the hydrogen fuel electrode-side catalyst layer 29B through the hydrogen gas diffusion layer 27 is decomposed to hydrogen ions and electrons by the function of a catalyst. The hydrogen ions pass through the electrolyte layer 25 to arrive at the oxygen electrode-side catalyst layer 29A. On the other hand, the electrons are extracted from the lens driving power generation cell 20 through the hydrogen gas diffusion layer 27 and a hydrogen fuel electrode-side electrode 72, which have electrical conductivity, to be utilized as electric power. After that, the electrons arrive at the oxygen electrode-side catalyst layer 29A through the oxygen electrode-side electrode 71 and the oxygen gas diffusion layer 26. In the oxygen electrode-side catalyst layer 29A, oxygen gas supplied through the oxygen supply holes 28, the hydrogen ions, and the electrons are chemically bonded together by the function of the catalyst, thereby generating water as a product.

The reaction formulae are as follows.

Hydrogen fuel electrode: H₂→2H⁺+2e⁻

Oxygen electrode: ½·O₂+2H⁺+2e⁻→H₂O

The generated electric power is supplied through a switching circuit 80 to the lens motor 22 electrically connected to the hydrogen fuel electrode-side electrode 72 and the oxygen electrode-side electrode 71, for lens focusing, and to the image blurring control element 24 for maintaining an image in a stationary state even when the camera body vibrates at a time of image taking. In this embodiment, the single power generation cell structure is adopted. However, a stacked power generation cell structure in which a plurality of single power generation cells are stacked or a power generation cell structure in which a plurality of single power generation cells are arranged in a plane direction.

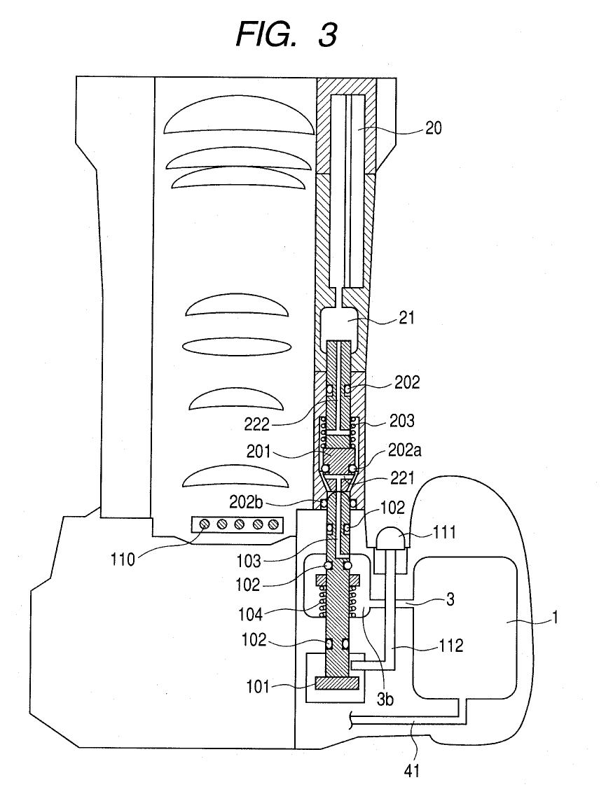

Next, examples of a connection portion between a camera body and an interchangeable lens are illustrated in FIGS. 3, 4, and 5.

FIG. 3 is a cross-sectional view illustrating a combined state where the interchangeable lens is mounted on the camera body.

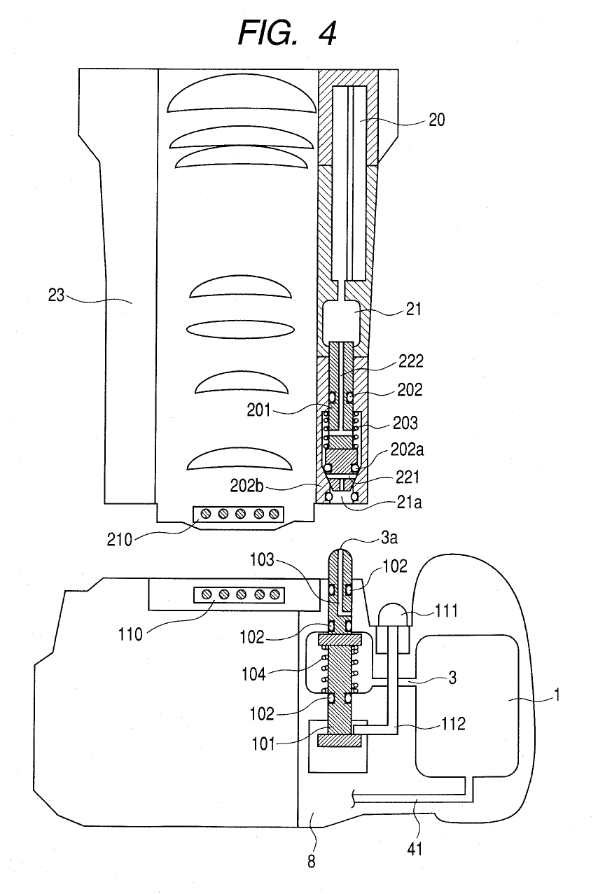

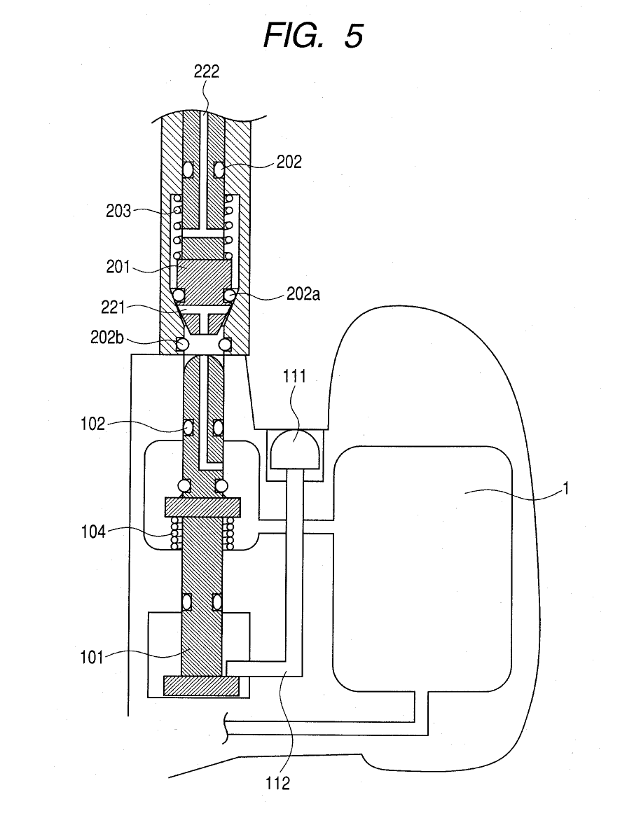

FIG. 4 illustrates a state where the interchangeable lens is not mounted on the camera body.

FIG. 5 illustrates a state when the interchangeable lens is detached from the camera body.

As illustrated in FIG. 4, a fuel sealing valve 101 contained in the camera body is a valve having a rod-like cylindrical shape and is disposed in the fuel flow path. On a cylindrical outer periphery of the fuel sealing valve 101, a plurality of circular O rings 102 are disposed each of which is made of an elastic material and has a circular section. The outer diameter of the O ring 102 is slightly larger than the inner diameter of the fuel flow path 3. The O ring 102 is brought into close contact with the inner periphery of the fuel flow path 3 thereby maintaining an airtight seal, so that even when a fuel gas pressure is applied thereto, the hydrogen fuel gas does not leak to the outside.

The fuel sealing valve 101 can be slidden in the axial direction while being in close contact with the inner periphery of the fuel flow path 3, and is allowed to protrude by a force of a compression spring 104. In a state where the interchangeable lens is not mounted, the fuel sealing valve 101 seals the hydrogen fuel supply from the fuel tank 1.

In a part of the fuel sealing valve 101, a sealing valve flow path 103 having a hole shape is formed. When the shaft of the fuel sealing valve 101 is pushed in, the fuel is allowed to flow through the sealing valve flow path 103 to the lens driving power generation cell 20 (see FIG. 3).

As illustrated in FIG. 4, like the fuel sealing valve 101, a fuel sealing valve 201 contained in the interchangeable lens is also a valve having a rod-like cylindrical shape and is disposed in the fuel flow path 21.

On the cylindrical outer periphery of the fuel sealing valve 201, a plurality of O rings 202 are also disposed. The O rings 202 are in close contact with the inner periphery of the fuel flow path 21, thereby preventing the hydrogen fuel remaining in the interchangeable lens from leaking to the outside.

The fuel sealing valve 201 can also be slidden in the axial direction and pushes out a shaft thereof by a force of a compression spring 203. When the interchangeable lens is not mounted on the camera body, an O ring 202a is pressed to an inclined surface of a conical shape of the fuel flow path, thereby achieving sealing.

In a part of the fuel sealing valve 201 of the interchangeable lens, hole-like sealing valve flow paths 221 and 222 are formed. When the shaft is pushed in, the fuel flows through the sealing valve flow paths 221 and 222 to the lens driving power generation cell 20.

In the combined state illustrated in FIG. 3, a distal end of the fuel sealing valve 201 contained in the interchangeable lens pushes the fuel sealing valve 101 deeply into the camera body, and the O ring 202b disposed in the fuel flow path of the interchangeable lens is brought into close contact with the outer periphery of a distal end portion of the fuel sealing valve 101.

With this structure, the fuel is prevented from leaking to the outside.

Further, the fuel sealing valve 201 on the interchangeable lens side is also pushed in by the fuel sealing valve 101 of the camera body, and the O ring 202a is moved away from the inclined surface of the flow path.

At this time, the fuel from the fuel tank 1 flows through the hydrogen fuel flow path 3, the hydrogen fuel flow path 3b, the sealing valve flow path 103, the sealing valve flow path 221, a gap formed by the movement of the O ring 202a, the sealing valve flow path 222, and the hydrogen fuel flow path 21 of the interchangeable lens in the mentioned order, thereby allowing the lens driving power generation cell 20 to perform power generation. During the power generation as well, air tightness in the flow path is maintained by the O ring 102 on the camera body side and the plurality of O rings 202 and 202b on the interchangeable lens side, thereby preventing the fuel from leaking to the outside.

In the camera body, an electrical contact portion 110 having a plurality of terminals is disposed, and when the interchangeable lens is combined with the camera body, the electrical contact portion 110 is brought into contact with an electrical contact portion 210 of the interchangeable lens. A part of the terminals can detect the mounting/dismounting of the interchangeable lens based on the electrical conduction of the electrical contact portions 110 and 210. Further, the other terminals function as electrical contact for circuit-connecting the camera body control portion 30 (FIG. 6) and the lens driving switching circuit 80 (FIG. 6) to each other.

Further, the fuel sealing valve 101 of the camera body also has a lens lock function for the camera body and the interchangeable lens. As illustrated in FIG. 5, when a user depresses a lens lock release button 111, a release button lever 112 slides to further push the fuel sealing valve 101 deeply into the camera body, thereby enabling the lens lock to be released. Accordingly, the fuel sealing valve 101 can also be applied to an interchangeable lens mount of the screw type which is a mainstream of a single-lens reflex camera or the like.

Next, a description will be made of a structural example of a system in which the interchangeable lens and a strobe light device are connected to the camera body according to this embodiment.

FIG. 6 is a schematic diagram of the system in which the interchangeable lens and the strobe light device are connected to the camera body.

In FIG. 6, the portions or parts which are the same as those shown in FIG. 1 are denoted by like numerals, so that the explanation thereof is omitted.

In FIG. 6, there is illustrated a camera body control portion 30 (drive control portion+power supply control portion) for performing drive control and power supply control of the camera body.

There are also illustrated an image processing portion 31, an imaging element 32, an exposure controller 33, a distance measuring portion 34, an image storage medium (memory) 35, and an image display portion 36 (monitor).

There are also illustrated a flow meter (for camera body) 90, a flow meter (for interchangeable lens) 91, a flow meter (for strobe light) 92, a lens motor switching circuit 80, and a strobe light switching circuit 81.

In this embodiment, the fuel tank 1 provided in the camera body 8 supplies the fuel to each of the body power generation cell 2 for driving the camera body 8, the lens driving power generation cell 20 for driving the interchangeable lens 23, and the strobe light power generation cell 40 for driving the strobe light, thereby realizing a distributed power supply arrangement.

First, the power generation cell 2 for driving the camera body supplies the generated electric power to the camera body control portion 30 for performing the drive control and the power supply control.

As a result, according to an operation mode of the camera body, drive control of the image processing portion 31, the imaging element 32, the exposure controller 33, the distance measuring portion 34, the image display portion 36, and the image storage medium 35 is performed.

Further, under the power supply control in the camera body control portion 30, according to a fuel consumption state in each of the independent power generation cells, each corresponding fuel supply amount is controlled in the following manner.

That is, the camera body control portion 30 functions as a fuel control unit for controlling the fuel supply amount supplied from the fuel storage vessel to each of the independent power generation cells in the following manner.

That is, the electric power consumption will vary according to the operation mode of the camera body.

Under the power supply control in the camera body control portion 30, the flow rate of the hydrogen fuel flowing through the camera body power generation cell 2 is controlled according to the electric power consumption thereof by a fuel flow rate control valve (for camera body) 10.

Further, the flow meter 90 for counting the total flow rate of the fuel passing through the hydrogen fuel flow path 7 is disposed. The flow meter 90 functions as a unit for detecting the fuel consumption amount, thereby integrating the consumption amount in the fuel tank 1.

Further, in the interchangeable lens 23, the lens driving power generation cell 20 is used to generate power for driving the lens motor 22 for adjusting the focal length of the lens by rotating the lens barrel and for driving the image blurring control element 24.

The output from the lens driving power generation cell 20 to which the hydrogen fuel is supplied from the fuel tank 1 allows the switching circuit 80 to be operated under the control by the camera body control portion 30.

As a result, a predetermined electric power is provided to the lens motor 22 for vibration and to the image blurring control element 24 to perform the control.

Further, also in the lens driving and the image blurring prevention, the electric power consumption will vary according to the operation mode.

By the power supply control in the camera body control portion 30, the flow rate of the hydrogen fuel flowing through the lens driving power generation cell 20 is controlled according to the electric power consumption state thereof by the fuel flow rate control valve (for interchangeable lens) 11.

Further, the flow meter 91 for counting the total flow rate of the fuel passing through the hydrogen fuel flow path 21 is disposed. The flow meter 91 functions as a unit for detecting a fuel consumption amount, thereby integrating the consumption in the fuel tank 1.

Further, in the strobe light 43, the strobe light power generation cell 40 is used for generating electric power for driving the strobe light emitting element 42 for light emission.

The output of the strobe light power generation cell 40 to which the hydrogen fuel is supplied from the fuel tank 1 allows the switching circuit 81 to be operated under the control of the camera body control portion 30 for performing the driving control and the power supply control of the camera body 8, thereby providing a predetermined electric power to the strobe light 43 to perform the control.

Also in the case of the strobe light, the electric power consumption will vary according to the number of times of light emitting operation.

Under the power supply control in the camera body control portion 30, the flow rate of the hydrogen fuel flowing through the strobe light power generation cell 40 is controlled according to the consumption state thereof by the fuel flow rate control valve (for strobe light) 12.

Further, the flow meter 92 for counting the total flow rate of the fuel passing through the hydrogen fuel flow path 41 is disposed. The flow meter 92 functions as a unit for detecting a fuel consumption amount, thereby integrating the consumption in the fuel tank 1.

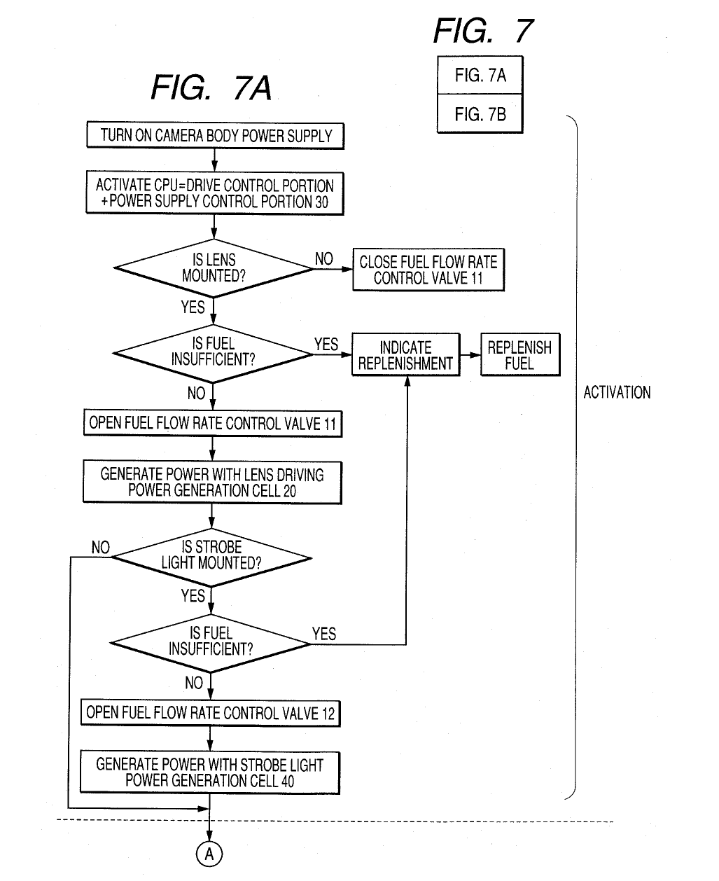

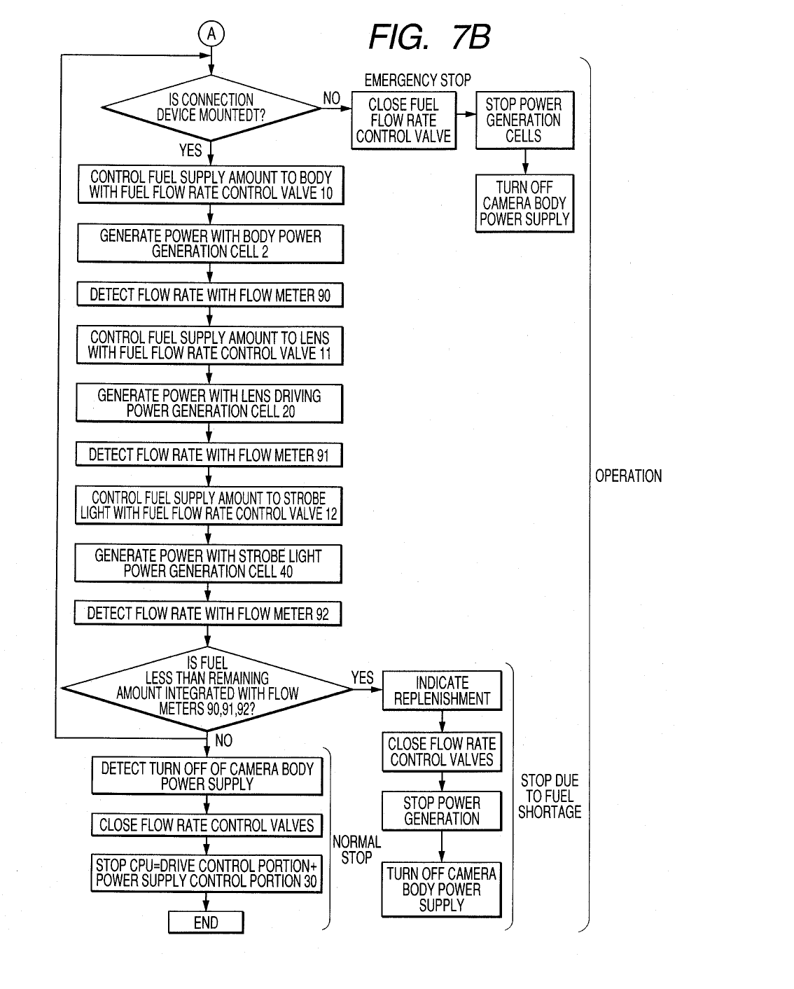

FIG. 7, which is composed of FIGS. 7A and 7B, is a schematic flow chart when the camera is activated and operates as an example of the system according to the present invention.

(Activation)

First, when a power supply of the camera body is turned on, by the electric power of the power generation cell 2 for driving the camera body, the camera body control portion (drive control portion+power supply control portion) 30 is activated.

Next, the camera body control portion 30 determines by use of the electrical contact portions 110 and 210 whether the interchangeable lens is mounted. When the interchangeable lens is not mounted, the fuel flow rate control valve 11 (FIG. 6) is kept in a closed state and the fuel supply to the lens driving power generation cell 20 is not performed.

When the interchangeable lens is mounted, the camera body control portion 30 calculates the remaining fuel amount from the previously integrated amount obtained through the counting by the flow meters 90, 91, and 92 to determine whether the fuel for driving the lens exists. When the replenishment of the fuel is not necessary, the fuel flow rate control valve 11 (see FIG. 6) is opened to supply the fuel to start power generation by the lens driving power generation cell 20.

Next, the camera body control portion 30 determines whether the strobe light is mounted, as is the case with the interchangeable lens. When the mounting thereof is detected, the fuel flow rate control valve 12 is opened to supply the fuel to start power generation by the strobe light power generation cell 40.

During the power generation, when it is determined that the fuel is insufficient as compared to the value integrated unifiedly, fuel replenishment is indicated on the image display portion 36.

(Operation)

Even when the camera is in operation, the camera body control portion 30 constantly performs the detection of the mounting and dismounting of each of the interchangeable lens and the strobe light device.

The fuel supply to the camera body power generation cell 2 is controlled by the fuel control valve 10. The output of the camera body power generation cell 2 is used for driving the components of the camera body, such as the image processing portion 31 and the image display portion 36. The fuel consumed by the camera body is counted for a total flow rate of the fuel which passes through the hydrogen fuel flow path 7 by use of the flow meter 90.

The fuel supply to the lens driving power generation cell 20 is controlled by the fuel control valve 11. The output of the lens driving power generation cell 20 is used for driving the lens motor 22 or the like. The fuel consumed by the interchangeable lens is counted for the total flow rate of the fuel which passes through the hydrogen fuel flow path 3 by use of the flow meter 91.

The fuel supply to the strobe light power generation cell 40 is controlled by the fuel control valve 12. The output of the strobe light power generation cell 40 is used for driving the strobe light emitting element. Regarding the fuel consumed by the strobe light, the total flow rate of the fuel which passes through the hydrogen fuel flow path 5 is counted by use of the flow meter 92.

The camera body control portion 30 unifiedly calculates the fuel consumption amount (remaining amount) from the integrated amount counted by means of the flow meters 90, 91, and 92. Further, the camera body control portion 30 stores a value thereof.

Even in a case where the connection devices are accidentally detached from the camera body during the operation, the separation of contact of the electrical contact portions 110 and 210 is detected and the fuel flow rate control valves 10, 11, and 12 are immediately closed to stop the power generation of the power generation cells, thereby turning off the power supply of the camera body.

As described above, the camera body control portion 30 for performing the drive control and the power supply control of the camera body unifiedly calculates the remaining amount of the hydrogen fuel in the fuel tank based on the result of the detection of the means for detecting the fuel consumption amount and indicates the remaining amount on the image display portion 36.

That is, the camera body control portion 30 unifiedly calculates the remaining amount of the hydrogen fuel in the fuel tank based on the integrated amount of the hydrogen fuel supplied from the fuel tank 1 to each of the camera body power generation cell 2, the lens driving power generation cell 20, and the strobe light power generation cell 40, and indicates the remaining amount on the image display portion 36.

In this embodiment, the remaining amount in the fuel tank is calculated from the total flow rate of the hydrogen fuel. However, the remaining amount of the fuel may be detected by another method, for example, by using the total of the electric power consumptions of the power generation cells and indicating the remaining amount.

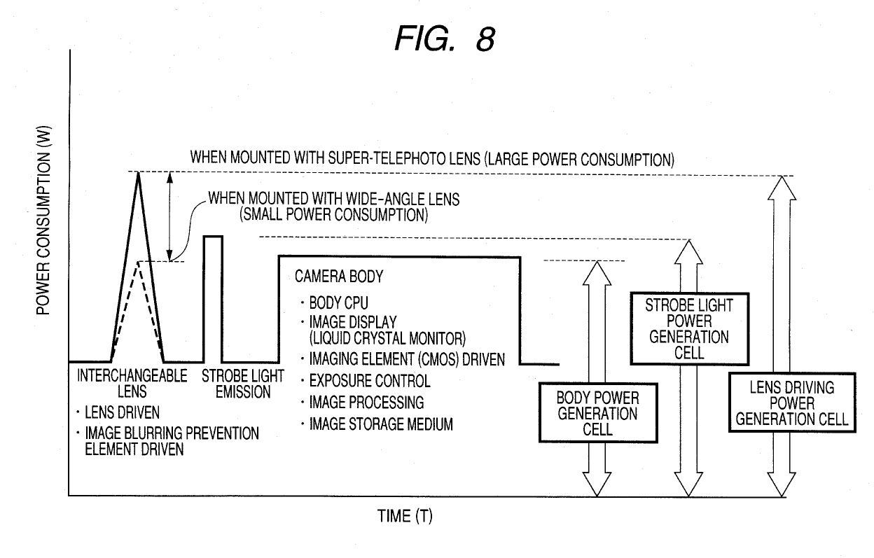

FIG. 8 is a graphical representation illustrating a relationship between electric power consumptions when an interchangeable lens and a strobe light as connection devices are mounted on a camera body.

Comparing the cases where a wide-angle lens is mounted as an interchangeable lens and where a super-telephoto lens is mounted as an interchangeable lens, the electric power consumptions are different from each other because the lenses thereof are different from each other in size and the driving motors therefor are different from each other in specification. The electric power consumption of the driving motor when the super-telephoto lens is mounted is larger than that in the case where the wide-angel lens is mounted.

On the other hand, a maximum value of the electric power consumption at the time of light emission of the strobe light emitting element is not as large as the electric power consumption when driving the super-telephoto lens motor, but the consumption time is longer because a charging time is required.

In the camera body, there are provided the image processing portion 31, the imaging element 32, the exposure controller 33, the distance measuring portion 34, the image display portion 36, the image storage medium 35, and the like, so that a smaller electric power is required than that required by the interchangeable lens or the strobe light, but the time during which the electric power is consumed is longer as compared to those of the interchangeable lens or the strobe light.

In the case of an electronic equipment which uses a connection device showing a wide variety of power consumptions, such as an interchangeable lens, ranging from a super-telephoto lens with a large electric power consumption to a macro lens with a small electric power consumption, the present invention has a great effect.

As described above, for example, in a portion where a large current is required, a power generation cell having a large area is provided, and in a portion where a small current is required, a power generation cell having a small area is provided. That is, a minimal power supply can be disposed in a required portion.

According to the camera system according to this embodiment described above, the hydrogen storage alloy tank is disposed only on the camera body side, and the connection devices are allowed to generate power by fuel supplied from the camera body, so that the detection of the state of the fuel tank and the electric power supply control can be unifiedly performed on the camera body side.

As a result, without the need of the complicated battery operation system as with those used in the background art, a camera system with a simple fuel cell can be realized.

Incidentally, although in the above embodiments, the description has been made by taking, as an example, the fuel cell system in which hydrogen gas stored in the hydrogen storage alloy is used as a fuel, the present invention can also be applied to a fuel cell of another mode, for example, one in which ethanol is used as a fuel.

Further, the description has been made of the electronic equipment according to the present invention by taking a digital single-lens reflex camera system as an example. However, the present invention can be applied not only to the digital single-lens reflex camera system, but also to a small electronic equipment, for example, a compact camera, a PDA, a mobile phone, or a notebook personal computer.

In the case of a personal computer system, a fuel tank charged with hydrogen fuel is provided to a portable personal computer body, and there is also provided a power generation cell for driving the personal computer body. A printer, a recording medium driving device, and the like, which are representative peripheral devices to be connected to the personal computer body, having an independent power generation cell may be connected to and integrated with the personal computer body.

In the case of a mobile phone system, a fuel tank charged with hydrogen fuel is provided to a mobile phone body and there is provided a power generation cell for driving the mobile phone body. A radio, a television receiver tuner, an audio player, and the like having an independent power generation cell may be connected to and integrated with the mobile phone body.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-019987, filed Jan. 30, 2007, which is hereby incorporated by reference herein in its entirety.

What is claimed is:

1. An electronic equipment system comprising:
an electronic equipment body;
a connection device connected to the electronic equipment body;
independent power generation cells each disposed to the electronic equipment body and to the connection device; and
a fuel storage vessel disposed to the electronic equipment body,
wherein fuel from the fuel storage vessel is suppliable to each of the independent power generation cells.

2. The electronic equipment system according to claim 1, wherein the electronic equipment body comprises a fuel control unit for controlling an amount of the fuel supplied to each of the independent power generation cells from the fuel storage vessel.

3. The electronic equipment system according to claim 2, wherein the fuel control unit controls the fuel supply amount depending on a fuel consumption amount in each of the independent power generation cells.

4. The electronic equipment system according to claim 3, wherein the electronic equipment body comprises a unit for detecting the fuel consumption amount.

5. The electronic equipment system according to claim 4, wherein the electronic equipment body comprises an image display portion for displaying a remaining amount of the fuel in the fuel storage vessel based on a detection result of the unit for detecting the fuel consumption amount.

6. The electronic equipment system according to claim 1, which is a camera system, wherein the connection device connected to a camera body is at least one of an interchangeable lens and a strobe light, and wherein as the independent power generation cells, a body power generation cell, a lens driving power generation cell, and a strobe light power generation cell are disposed to the camera body, the interchangeable lens, and the strobe light, respectively.
